(19) United States
(12) Patent Application Publication
(10) Pub. No.: US 2006/0259468 A1
(43) Pub. Date: Nov. 16, 2006

(54) Methods for electronic records management

(76) Inventors: Michael Brooks, Killinchy (GB); Siobhan Brown, Magherafelt (GB); Alistair Craig, Saintfield (GB); Philip Crooks, Bangor (GB); Alan Gilmore, Holywood (GB); Neal Gordon, Belfast (GB); Graham Lee, Belfast (GB); Bernadette Mccoy, Randalstown (GB); Connor Mulholland, Lurgan (GB); Desmond Murphy, Belfast (GB); Andrew Reid, Dundonald (GB); Geoff Taylor, Carrickfergus (GB)

Correspondence Address: WILMER CUTLER PICKERING HALE AND DORR LLP, 399 PARK AVENUE, NEW YORK, NY, 10022, US

(21) Appl. No.: 11/126,984

(22) Filed: May 10, 2005

(51) Int. Cl. G06F 17/30

(52) U.S. Cl. 707/3

(57) ABSTRACT

Systems and methods for the management and organization of electronic records are disclosed. These systems and methods provide the user with capabilities such as inputting and retrieving documents, searching for documents and sharing documents across an organization. The systems and methods also allow the capture of unstructured electronic records not typically associated with document management systems like, for example, email or instant message conversations, allow for remote update of replicated data between electronic record management systems to ensure integrity and consistency of the electronic records, allow for structured replication of electronic records between remote and master systems, and provide a mechanism for rectifying multiple disposal rules that may apply to the same electronic record.

### FIELD OF INVENTION

The present invention relates to methods for electronic records management. More particularly, the present invention relates to methods for electronic records management that provide automated electronic record capture, replication, update, and/or retention control.

### BACKGROUND OF THE INVENTION

In a modern business, computers, scanners, cameras, and facsimile machines are an essential part of day-to-day operation. For example, computers are used to keep track of businesses' financial data, to generate electronic invoices, to pay invoices, to take orders, to communicate (e.g., via email, instant message devices, web chat), to create documents and brochures, to post web pages, etc. Similarly, scanners, cameras, and facsimile machines are used to turn physical documents and objects into electronic documents and images, and to communicate the electronic documents and images to remote places.

With computers and other electronic devices being used so extensively in modern businesses, it is understandable that electronic records have become critical for daily operation as well as historical record keeping. Moreover, in the wake of recent accounting scandals and legislation like the United States' Sarbanes-Oxley Act, properly maintaining these electronic records has become necessary to avoid costly investigations and civil and criminal lawsuits.

Because of these and other reasons, electronic record management systems (ERMSs) are becoming widely adopted by businesses. These ERMSs allow a user to store, control access to, and control the deletion of electronic records as well as provide a means to catalog and search electronic records using a wide variety of criteria. As used herein, an electronic record may include any form of electronic information, such as documents (e.g., a MICROSOFT WORD document or an ADOBE PDF file), a spreadsheet, an electronic mail message, an instant messaging conversation, a Web page, etc.

Although current ERMSs provide a great deal of functionality for maintaining electronic records, there are several areas where these systems could be improved. For example, as the number of electronic records such as emails, instant messaging conversations and the like has increased, so too have the legal requirements for capturing and storing these records. Current systems for batch processing of electronic records generally rely on hard coded, inflexible rule sets and are not easily configured to meet different record retention requirements. Other systems for dealing with large numbers of electronic records rely on a great deal of user intervention thereby increasing the time and cost associated with record retention compliance as well as the potential for errors as these systems are increasingly distributed across large organizations. Thus, it would be desirable to provide more flexible mechanisms for capturing electronic documents in ERMSs.

As another example, because many organizations deploying ERMSs today are geographically diverse, and are often spread across a campus, a city, a province, or, in some cases, the entire world, ERMSs need to be able provide distributed architectures wherein local ERMSs can provide electronic records to local users, while maintaining the appearance of being a centralized architecture that contains all of the electronic records of the organization. Achieving these goals requires effective techniques for managing and replicating data across multiple sites, nodes, systems, etc. Thus, it would be desirable to provide more efficient mechanisms for managing and replicating data across such distributed architectures.

As a further example, the distributed architectures described above also make it difficult to ensure that record integrity is preserved when multiple users attempt to access and modify an electronic record. In such cases, there may be several individuals in geographically diverse sites who wish to add or edit electronic records. Adding to this complexity, it may be that different users wish to edit the same record over a period of time. For example, one user might edit a document today and save the change tomorrow. Another user, who is in a remote location, may also wish to edit the same document, but be prevented from doing so until tomorrow. As a more detailed example, assume that a headquarters of an organization A has decided to open sales offices B and C. There is an existing ERMS in A and the organization wishes to replicate some of the data in A to users in B and C. The master electronic records will be maintained in A but B and C might need to change certain information in one or more of the master records. One solution would be to set up A, B and C as “peers”; that is each one having full access to add, modify or delete records on another system. Obviously, this would have an effect on data integrity as there would be no supervisory control over the master electronic records. Another solution—and the one common to most current ERMSs—is to designate one system as a “master” and the others as “slaves.” In this situation, all requests for changes to an electronic record are passed through a single node which can apply the requested changes to the record. This approach however has some significant shortcomings. First, it is time consuming and burdensome, especially on the individual or organization which must evaluate and act upon such requests. One user must be designated as the ultimate “change arbiter” who has to decide how conflicting changes to the same document must be reconciled. Second, it assumes that all of the nodes are in constant contact with one another and further assumes that updates are communicated to all the nodes in the ERMS in real time and that all change requests are of equal importance. Third, it cannot cope with situations where different users have differing ability to amend a record. Putting these shortcomings into the example may be informative. Assume that A, B and C are not in constant contact with one another. For example, assume that B is a network node that is only updated weekly to save network load and communications costs. When B is updated it may be that A and C have already moved to more current data. Assume further that B requests a change based on data that hasn't been updated and is not aware that C has already made a change which renders B's proposed change irrelevant or even contradictory. Thus, it would be desirable to provide new mechanisms for updating electronic records across distributed architectures.

As yet another example, as the document retention and disposal needs of organizations has increased in complexity (e.g., as dictated either by internal organizational controls or external statutory mandates such as Sarbanes-Oxley), the process of managing electronic record disposal has become much more complicated. For example, an ERMS may provide many alternative mechanisms by which a disposal schedule may be associated with a record. In today's business environment, it is possible that a combination of factors will create a situation whereby multiple disposal schedules are identified as candidates to be assigned to a specific record. Thus, it would be desirable to provide a mechanism to ensure that disposal schedules are applied to electronic records in a manner such that disparate record retention requirements are met.

### SUMMARY OF INVENTION

In accordance with the present invention, systems and methods for the management and organization of electronic records are disclosed. An Electronic Record Management System (ERMS) generally provides the user with capabilities such as inputting and retrieving documents, searching for documents and sharing documents across an organization. The ERMS disclosed herein expands these functions by allowing the capture of unstructured electronic records not typically associated with document management systems, for example, email or instant message conversations. The ERMS may also allow for remote update of replicated data between electronic record management systems to ensure integrity and consistency of the electronic records. The ERMS may further allow for structured replication of electronic records between remote and master systems. The ERMS may yet further provide a mechanism for rectifying multiple disposal rules that apply to the same electronic record.

More particularly, in accordance with certain embodiments of the present invention, methods for capturing electronic records are provided. These methods include: receiving an electronic record from a process chain initiator at an electronic records management system; selecting one of the at least one process chain definition; based on the selected one of the at least one process chain definition, selecting at least one element to be processed on the electronic record; and executing the at least one element on the electronic record.

In accordance with other embodiments of the present invention, methods for capturing electronic records in an electronic record management system are provided. These methods include: monitoring for the occurrence of an electronic record; in response to the electronic record being detected, creating metadata for the electronic record; comparing at least one of the electronic record and the metadata to at least one rule; and if the rule is satisfied, performing a custom element operation on at least one of the electronic record and the metadata.

In accordance with further embodiments of the present invention, methods for replicating data among a plurality of electronic records management systems are provided. These methods include: receiving data to be replicated from a first electronic records management system through a first application program interface at a first node and storing the data in a first database at the first node; retrieving the data from the first database and sending the data through a base transport from the first node to a second node; receiving the data at the second node and storing the data in a second database at the second node; retrieving the data from the second database and sending the data through the base transport from the second node; receiving the data at an nth node and storing the data in an nth database at the nth node; and retrieving the data from the nth database and providing the data through a second application program interface to a second electronic records management system.

In accordance with yet further embodiments of the present invention, methods for updating electronic records through an electronic records management system are provided. These methods include: providing a master electronic record at a first node; providing a replica electronic record that is a replica of the master electronic record at a second node; permitting a first user to make modifications to the master electronic record; permitting a second user to make modifications to the replica electronic record;
transmitting the modifications to the replica electronic record from the second node to the first node; at the first node, comparing the modifications to the master electronic record to the modifications to the replica electronic record to determine if the modifications to the replica electronic record will be entered; and at the first node, determining whether to reject the modifications to the replica electronic.

In accordance with still further embodiments of the present invention, methods for retaining electronic records in an electronic records management system are provided. These methods include: comparing multiple disposal schedules applicable to an electronic record to determine a single disposal schedule for the electronic record; setting a disposal configuration of a storage device that is compatible with the single disposal schedule; storing the electronic record in the storage device; and taking a disposal action on the electronic record in accordance with the single disposal schedule.

### DESCRIPTION OF DRAWINGS

The above and other objects and advantages of the present invention will be apparent upon consideration of the following detailed description, taken in conjunction with accompanying drawings, in which like reference characters refer to like parts throughout, and in which:

FIG. 1 is a diagram of the system architecture in accordance with certain embodiments of the present invention;

FIG. 2 is a diagram of an electronic record capture process in accordance with certain embodiments of the present invention;

FIG. 3 is a diagram of a more particular electronic record capture process in accordance with certain embodiments of the present invention;

FIG. 4 is a diagram of an email capture process in accordance with certain embodiments of the present invention;

FIG. 5 is a diagram of an instant messaging conversation capture process in accordance with certain embodiments of the present invention;

FIG. 6 is a diagram of a replication transport feature in accordance with certain embodiments of the present invention;

FIG. 7 is a diagram of a transport services mechanism in a replication transport feature in accordance with certain embodiments of the present invention;

FIG. 8 is a diagram of a replication transport process in accordance with certain embodiments of the present invention;

FIG. 9 is a flowchart of a remote update of replicated data process in accordance with certain embodiments of the present invention; and

FIG. 10 is diagram of a disposal process in accordance with certain embodiments of the present invention.

### DETAILED DESCRIPTION OF THE INVENTION

In accordance with the present invention, improved systems and methods for the management and organization of electronic records are disclosed. These electronic record management systems (ERMSs) generally provide users with capabilities such as inputting and retrieving documents, searching for documents and sharing documents across an organization. The ERMSs disclosed also provide capabilities for the capture of unstructured electronic records not typically associated with record management systems like, for example, email or instant message conversations, for the remote updating of replicated data between electronic record management systems to ensure integrity and consistency of the electronic records, for the structured replication of electronic records between remote and master systems, and for rectifying multiple disposal rules that may apply to the same electronic record.

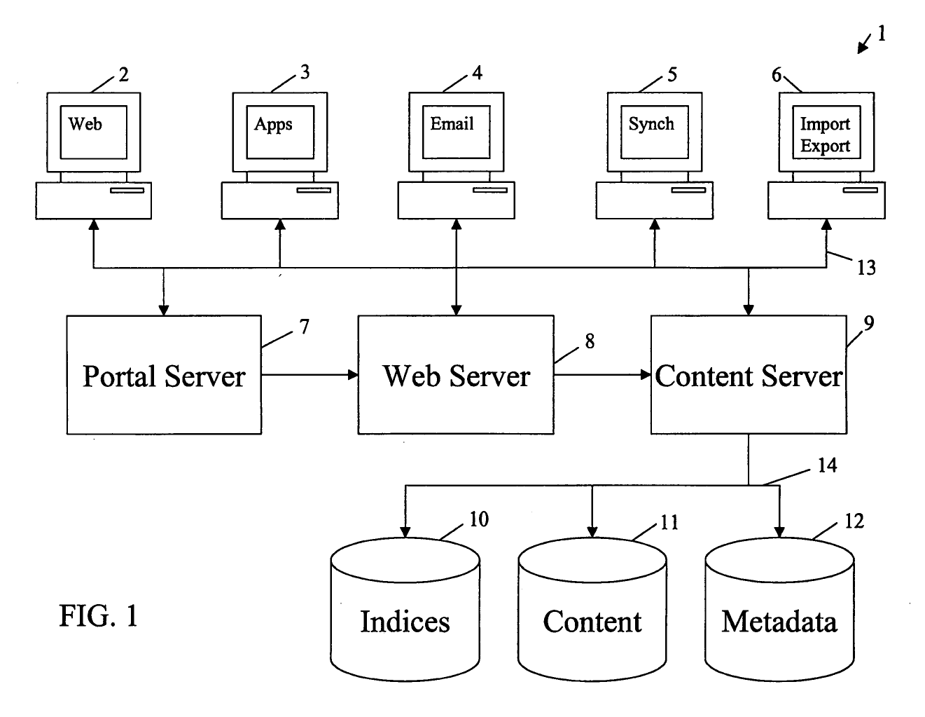

FIG. 1 illustrates an example of an ERMS architecture 1 in accordance with certain embodiments of the invention. As shown, architecture 1 includes one or more terminals 2-6, one or more servers 7-9, one or more databases 10-12, and one or more networks 13 and 14. Terminals 2-6 may be any suitable user access devices and may be Internet browsers running on personal computers, may be client computers running applications such as MICROSOFT WORD, or may be any other suitable devices. As shown, terminal 2 provides Web access, terminal 3 provides desktop applications such as word processing, terminal 4 provides email access, terminal 5 provides synchronization software, and terminal 6 provides import and export functions. Servers 7-9 may be any suitable computer or devices. The servers may provide access to the ERMS via Simple Object Access Protocol (SOAP), Common Object Model (COM), Open Document Management API (ODMA), Message Application Program Interface (MAPI), or any other suitable technique. Portal server 7 may be any suitable server for providing portals to users of the ERMS, such as MICROSOFT SHAREPOINT portal server or any other suitable device. Web server 8 may be any suitable server for enabling Web access to the ERMS. Content server 9 may be any suitable device for controlling access to databases 10-12, and may provide the core management functions of the ERMS. Databases 10-12 may be any suitable storage devices for storing indices, content, and metadata, respectively, and may be implemented using any suitable data storage mechanisms, such as a Structured Query Language (SQL), ORACLE, or MICROSOFT ACCESS database, a disk drive, memory, or any other suitable device(s). Although databases 10, 11, and 12 are illustrated separately in FIG. 1, these databases could be combined if desirable. Lastly, networks 13 and 14 may be any suitable networks for communicating among the components of FIG. 1, such as a WAN, LAN, the Internet, or any combination of these.

More particularly, content server 9 may handle various processes conducted by the ERMS such as searching for records, checking records against rules and processing new records. A records manager, who is in charge of maintaining an organization's records, may access content server 9 to modify settings and develop rules to govern the actions of the ERMS through a terminal (not shown), Web client or by any other suitable means.

The ERMS may be integrated into applications such as Microsoft Word and PowerPoint through the Open Document Management API (ODMA), and replace the standard file management dialog boxes. ODMA is a standard interface for linking applications to document management systems, and is well known in the art.

As described above, access to the ERMS functionality, in certain embodiments, may be available to users from a standard web browser via a web server 8. Web servers 8 may be composed of custom web applications and web extensions. Custom web applications may be web-based programs that allow system users to access and use data found on content server 9 as well as the data and functionality of databases 10-12. The custom web applications may be developed to provide specific functionalities and accessibility options to the users. Web extensions may allow system users to access and use the ERMS from remote locations. Web extensions may be thought of as one or more dynamic web pages that may be accessed by users on remote machines. The web extensions may be hosted by web server 8 and may be given a universal resource locator (URL) so system users can access the ERMS with the use of a web browser. Integration with Microsoft SharePoint Server at portal server 7 may allow access to databases 10-13 through a graphical user interface.

In addition to the features of an ERMS described above, in accordance with the present invention, an ERMS may also provide one or more of the features described below. The functions described below may be implemented in content server 9 or in any other suitable component(s) of an ERMS.

Document Capture

As described above, known electronic record management systems (ERMS) typically require manual user interaction for documents, whether in paper or electronic form, to be entered into the systems. For example, in such systems, each document needs to be imported into an ERMS and a profile for the document (whether wholly or partially) manually created by a Records Manager or his designate. Some known systems also included the capability to automatically capture certain types of documents, but for each type of document to be captured, a separate and distinct capture mechanism must be created. Current capture systems are not easily redeployed when there is a need to capture a different type of document or the existing capture workflow must be changed.

In accordance with the present invention, an ERMS may include the capability to automatically detect, tag, and store electronic records using a customizable process. In certain embodiments, this process may be implemented by performing any number of configurable elements to capture, filter, augment, and store electronic records.

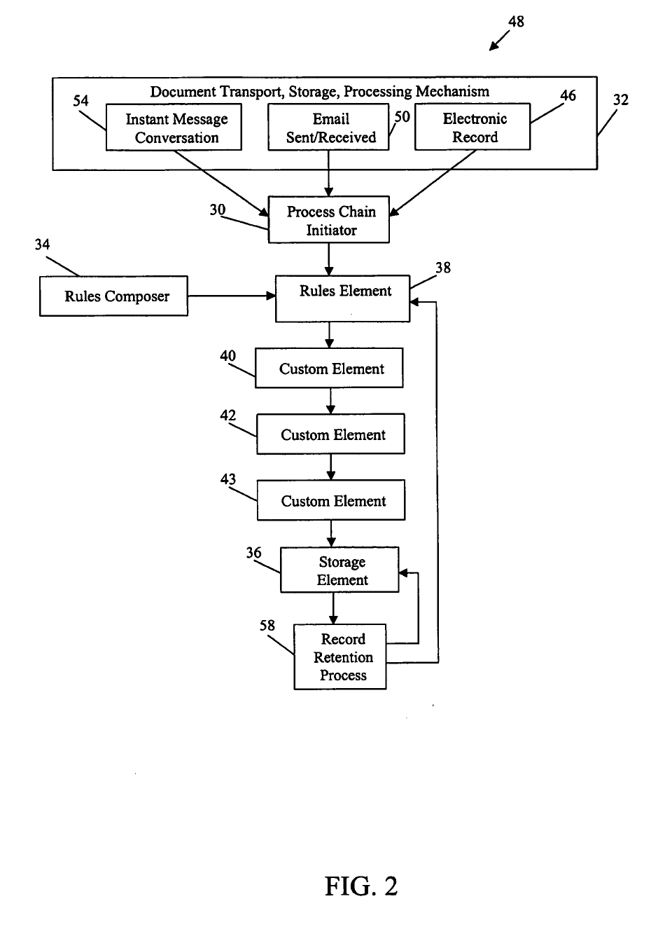

FIG. 2 illustrates an example of a logical architecture 48 for implementing this feature of the present invention. As shown, architecture 48 may include the following mechanisms: a document transport, storage, processing mechanism 32; a process chain initiator 30; a rules element 38; a rules composer 34; custom elements 40, 42, and 43; a storage element 36; and a record retention process 58. These mechanisms may be implemented in any suitable data processing and/or data storage device, or devices, capable of performing the functions of these mechanisms as described herein. For example, mechanism 32 may be implemented in email or instant messaging servers, computer network devices for extracting network traffic off a network, databases, etc., and process chain initiator 30, rules element 38, rules composer 34, custom elements 40, 42, and 43, and record retention process 58 may be implemented in one or more general purpose computers, and storage element 36 may be implemented in any suitable mechanism, whether hardware or software, for the storage of content including but not limited to a designated file system or database, a designated hardware storage device such as a disk drive or optical media or a designated area within a Redundant Array of Inexpensive Disks (RAID) or Storage Area Network (SAN).

As also shown in FIG. 2, architecture 48 may be used to capture and process electronic records such as instant message conversations 54, sent/received emails 50, electronic records 46, streaming video and/or audio, voice over IP, and/or any other suitable types of data present in mechanism 32. More particularly, architecture 48 may operate as follows. First, process chain initiator 30 monitors mechanism 32 for electronic records to be captured. This monitoring may be performed continuously or upon some suitable periodic basis, such as once an hour, every five minutes or any other suitable interval desired. When an appropriate electronic record is detected, process chain initiator 30 then captures the electronic record and creates an Extensible Markup Language (XML) metadata package for the record. XML is a data format for structured document interchange over standard Web protocols. This metadata may be extracted from the electronic record, such as but not limited to existing XML tags within the electronic record, or may be obtained from any other suitable data source. The XML metadata may indicate such information as keywords found in the electronic record, the date, time, and/or originator of the electronic record, or any other suitable information associated with the electronic record. Process chain initiator 30 may alternatively format the metadata in any other suitable format such as Standard Generalized Markup Language (SGML), or HyperText Markup Language (HTML). Finally, process chain initiator 30 forwards the electronic record and/or the metadata to the next element in the chain, which in the instant example is the rules element 38.

Upon receiving the electronic record and/or metadata, rules element 38 analyzes the metadata against rules to determine the correct action for the electronic record. The rules used to determine the correct action for the electronic record may be manually configured by a Records Manager using rules composer 34. Alternatively, the rules may be automatically configured by rules composer 34 using artificial intelligence, pattern recognition (such as Bayesian pattern recognition), or any other suitable mechanism, or may be pre-configured in advance by an ERMS vendor or a System Integrator. The rules may include criteria for determining whether the captured electronic record should be saved, parameters for how long the electronic record should be retained and in what way the electronic record should be stored, and any other suitable requirements. Based on the rules, rules element 38 may update the metadata to reflect these requirements.

Once the rules are applied and the metadata updated, rules element 38 may pass the electronic record and its metadata to any suitable one or more custom elements 40, 42, and 43. Alternatively, the use of custom elements in process 48 could be omitted if desired. Such custom elements may be designed and written by a solution provider that sets up the ERMS, or by any other suitable party, and may perform any suitable functions on the electronic record and/or metadata. For example, the custom elements may perform automatic categorization of the electronic record by examining the content of the electronic record to determine what it is, may augment the electronic record by supplementing it with or linking to data from an external data source, may use data from the electronic record to modify the metadata, or perform any other suitable function on the electronic record or metadata.

After completing processing, the electronic record and metadata is passed from the custom elements to one or more storage elements 36 for storage. The storage elements may store the electronic record and metadata together or separately. The electronic record and metadata may be indexed in storage element 36 using any suitable technique. Record retention process 58 then monitors the metadata associated with each electronic record stored in storage element 36 and deletes the electronic record and metadata if and when appropriate.

In order to facilitate the transfer of the electronic record and metadata to rules element 38, custom elements 40, 42, and 43, and storage element 36, process chain initiator 30 places the electronic record and the metadata into a package in a given format that is preferably maintained through out processing by rules element 38 and custom elements 40, 42, and 43. In this way, any element may be able to access the package and manipulate its contents without concern that the package will not be in a proper format.

In accordance with the present invention, the document capture feature includes a configurable process for determining which elements may be applied to different types of electronic records. For example, as shown in FIG. 2, one type of electronic record may be operated on by a rules element 38, custom elements 40, 42, and 43, and a storage element 36, whereas other types of electronic records may only be operated on by rules element 38, by storage element 36, by a custom element 40, or by any combination of these, and yet other electronic records may be operated on by only a storage element 36. In this configurable process, for each type of electronic record, a process chain initiator 30 is defined. This process chain initiator detects the existence of an electronic record at its source and forwards it to the next element in the process chain as defined by the configuration file. A series of elements to be performed is also defined in a process chain definition. These definitions may be stored in a configuration file if desired. Upon receiving an electronic record, the process chain initiator may then pass the electronic record to each of a series of elements in order based on a process chain definition. Process chain initiators and elements may be programmed in any suitable programming language. In this way, the document capture feature can be easily modified to capture different and new types of electronic records.

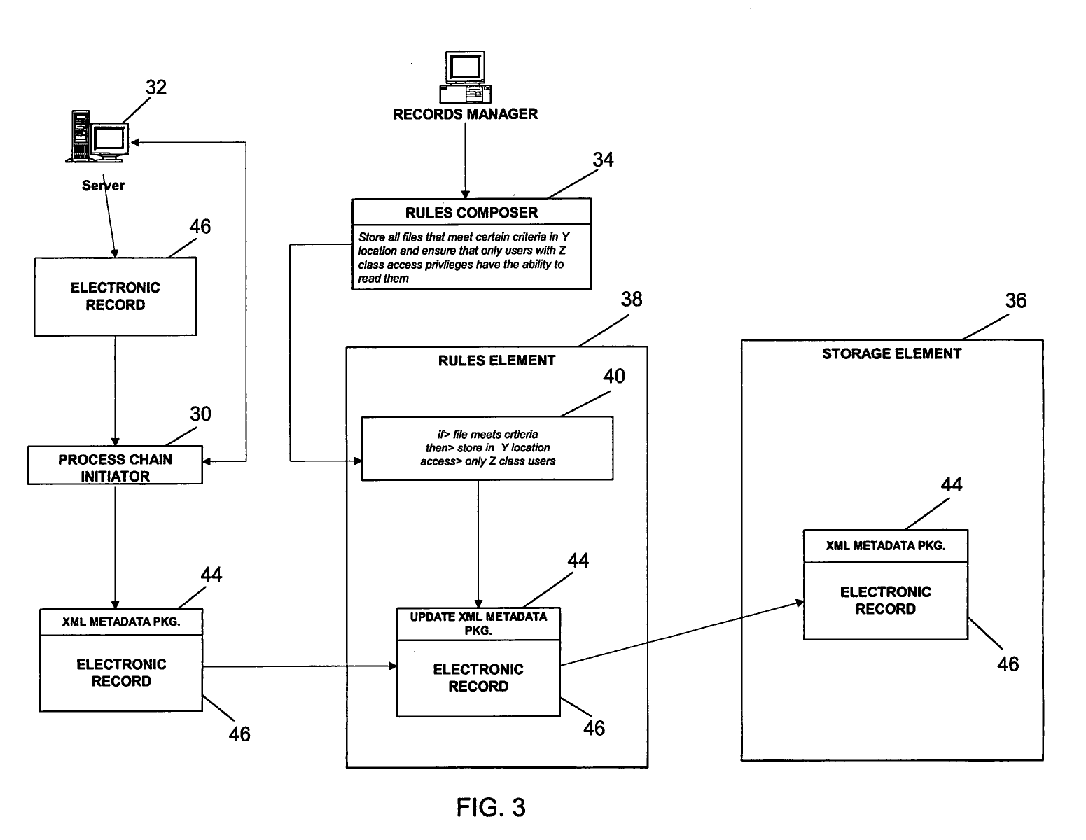

FIGS. 3-5 illustrate specific applications of the general process shown in FIG. 2 in accordance with certain embodiments of the present invention. As described above, each of these applications may be configured by a solution provider or the end-user to provide additional or alternative functionality using custom elements.

Turning to FIG. 3, an example of how an ERMS may handle an electronic file in accordance with some embodiments of the invention is illustrated. As shown, a document transport, storage, processing mechanism 32 implemented in a device such as a file server is monitored by process chain initiator 30 to determine when an electronic record 46 is created, modified, received, etc. When an electronic record 46 is available, process chain initiator 30 receives the electronic record from mechanism 32, creates an XML metadata package 44 associated with electronic record 46, and forwards package 44 and electronic record 46 to rules element 38.

Upon receiving package 44 and electronic record 46 from process chain initiator 30, the rules element then evaluates the electronic record in accordance with one or more rules 40 to determine whether and how to process the electronic record and metadata. For example, if electronic record 46 does not meet certain rules, it may not be stored in the ERMS at all. In other cases, it may be stored in encrypted format for a specified period of time. Obviously, any other suitable set of parameters for whether and how to process the electronic record and metadata could also be used.

Based on the rules, rules element 38 may then update XML metadata package 44 and pass package 44 and electronic record 46 to storage element 36 for storage. In certain embodiments, storage element 36 may query the metadata upon receipt to determine where, for how long and under what predefined conditions (restricted access, etc) the electronic record may be kept and then may store the electronic record accordingly.

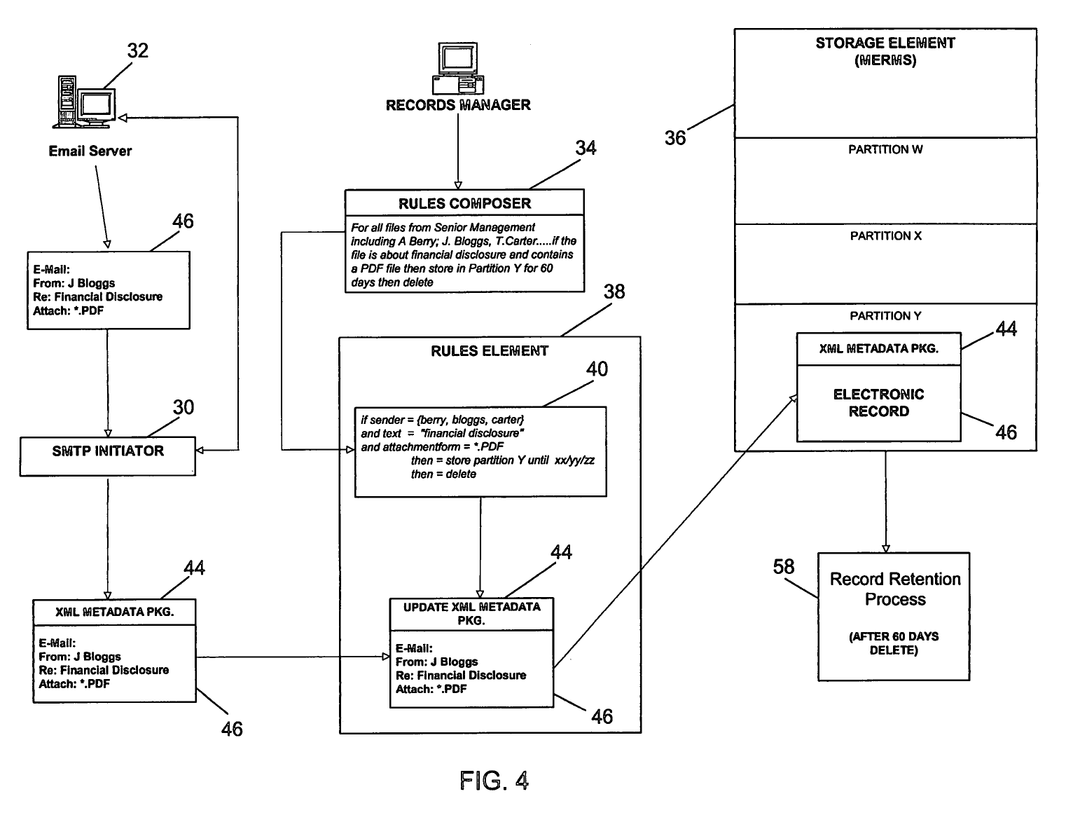

FIG. 4 illustrates an example of how an ERMS may be used to capture and store e-mail communications automatically in accordance with certain embodiments of the present invention.

As shown, in this example, the process chain initiator may be designed in accordance with the Simple Mail Transfer Protocol (SMTP) to form a SMTP initiator 30 that is capable of capturing e-mail 46 from mechanism 32, which may be implemented in an email server. Initiator 30 may examine all electronic mail 46 passing through a specific e-mail server or network of e-mail servers. For each such email, SMTP initiator 30 may create an XML metadata package 44 which identifies parameters within the e-mail such as, but not limited to, the source or destination of the message, the size of the message, the names or e-mail addresses of the recipients in the cc: or bcc: line, the presence or absence of certain keywords in the subject line, message body, header or footer, or any other suitable information. This XML metadata package 44 may be associated with the email 46, and then the email and metadata may be passed to rules element 38.

On receipt of email 46 and metadata 44 (or, in some embodiments, a notification that an electronic record meeting certain criteria has been received), rules element 38 compares the metadata to one or more rules 40 to determine whether and how the metadata and email should be processed. For example, rules element 38 may apply certain storage and retention rules to the electronic record based on the presence or absence of certain keywords, phrases or other parameters (such as length, presence or absence of attachments, priority level, read/delivered receipts, etc). As noted earlier, the exact parameters of rules element 38 may be predetermined by the Record Manager using rules composer 34. For example, the record manager may write a rule which states that all e-mails from senior management within a specific organization that contain the words “financial disclosure” and an attachment in ADOBE PORTABLE DOCUMENT FORMAT may be archived on a named secure storage medium for a period of not less than 60 days following which the e-mail and its contents may be securely deleted according to a specific electronic record deletion standard. Rules element 38 may also contain a rule 40 to apply different retention settings or storage placement depending on the company name or names found in the electronic record.

Once rules element 38 has completed processing email 46 and/or metadata 44, it may pass the e-mail and/or the metadata to storage element 36. Once storage element 36 receives the e-mail and/or the metadata, it may apply storage criteria determined by rules element 38. In this example, e-mail messages from certain predefined senior management personnel containing the words “financial disclosure” and an ADOBE PORTABLE DOCUMENT FORMAT attachment may be archived on a secure storage medium, for example, optical disk or tape.

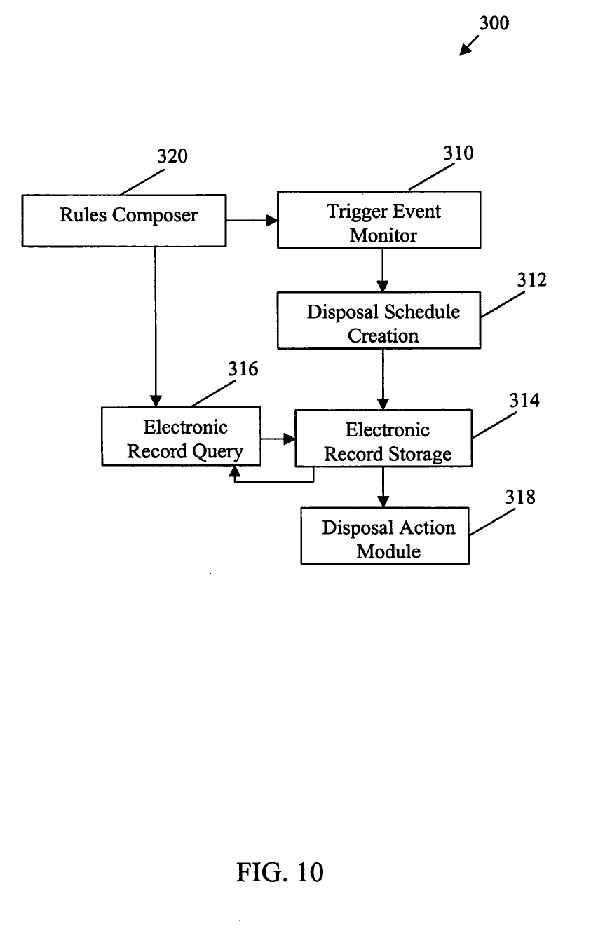

Record retention process 58 may then periodically check the stored email 46 and its metadata 44 to determine whether to dispose of the email and metadata. Record retention process 58, in some embodiments, may determine that two deletion rules conflict (e.g., one rule indicates to delete an electronic record in 60 days, while another indicates that the electronic record should not be deleted for three months), and automatically rectify this conflict (this is described further below in connection with FIG. 10). If record retention process 58 determines the electronic record should be retained, it may, in some embodiments, send the electronic record back to rules element 38 to update the retention requirements.

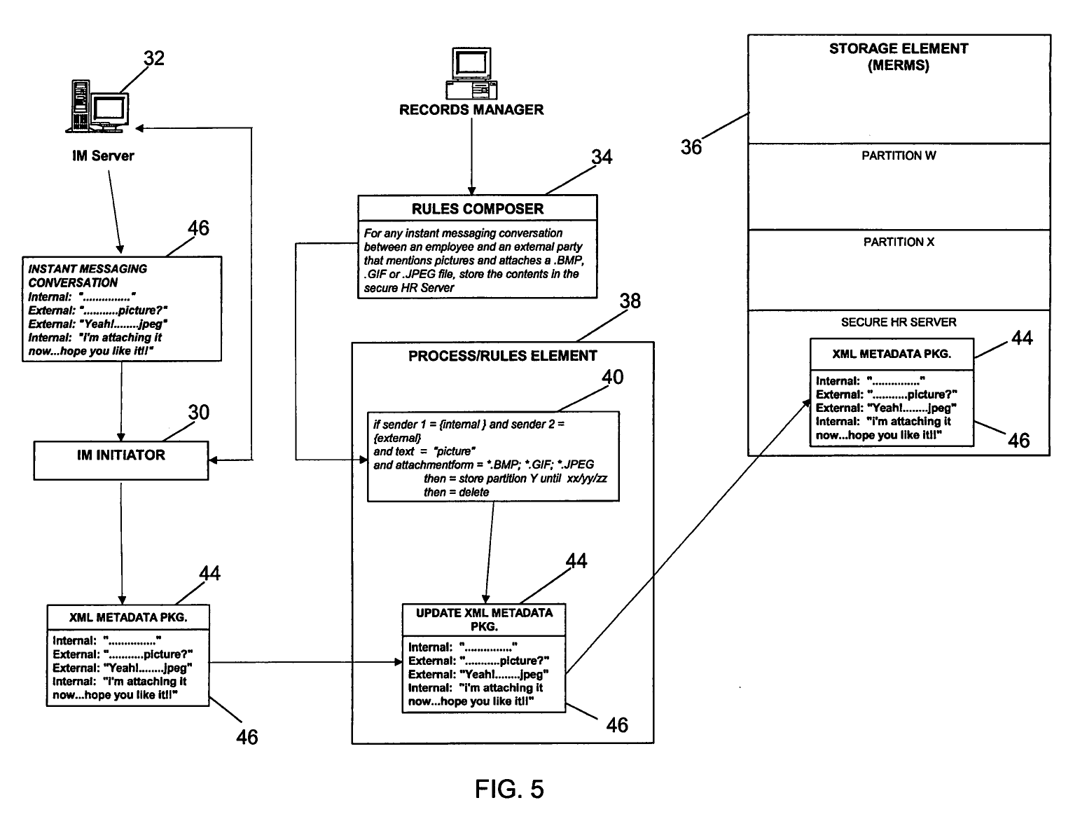

FIG. 5 illustrates an example of how an ERMS may be used to capture and store instant messaging (IM) communications automatically in accordance with certain embodiments of the present invention. As shown, the process chain initiator may be designed to capture instant messaging conversations 46, and hence is referred to in FIG. 5 as an IM initiator 30. IM initiator 30 may examine all instant messaging traffic passing through mechanism 32, which may be implemented in a specific messaging server or network of messaging servers. In certain embodiments, IM initiator 30 may be configured to query the text of an IM conversation 46 from its initiation for certain words, phrases or other parameters (such as length or duration). For each such conversation 46, IM initiator 30 may create XML metadata package 44 which identifies parameters in real time as the conversation develops such as, but not limited to, the parties to the conversation, the duration of the conversation, and similar attributes. XML metadata package 44 may be associated with the IM conversation 46 and the conversation and metadata passed to rules element 38.

On receipt of conversation 46 and metadata 44, rules element 38 may then apply predetermined storage retention criteria 40 to the metadata. In some embodiments, a notification that a conversation meeting certain criteria has been captured may be sent to rules element 38, which may then determine whether and how to store the conversation and metadata before it is passed to the rules element. As noted earlier, the rules 40 used by rules element 38 may be predetermined by a Records Manager using a rules composer 34. For example, the record manager may write a rule which states that all instant messaging conversations between an employee of a company and anyone outside the company which contains the keyword “picture” and an attachment with a .GIF, .JPEG or .PNG extension may be forwarded to a password protected section of storage element 36 accessible only by members of the organization's human resources (HR) staff.

Once rules element 38 has completed processing IM conversation 46 and/or metadata 44, it may pass the IM conversation and/or the metadata to storage element 36. Once storage element 36 has received the IM conversation and/or the metadata, it may apply the storage criteria that may be determined by rules element 38.

Replication Transport Mechanism

As described above, in accordance with the present invention, an ERMS may also include a replication transport mechanism for conveying replication data between separated electronic record management systems, or between different components of a single ERMS. As noted in the background section above, current replication transport mechanisms lack a degree of flexibility and custom control. In accordance with certain embodiments of the present invention, the replication transport mechanism preferably handles the transfer of replication data in a secure, network-efficient manner that can cope with disconnected situations such as where the sending system and the receiving system may be incapable of direct contact with one another for any number of reasons such as network problems or simply by design. Moreover, replication transport mechanisms in accordance with the present invention preferably complete the transfer with a degree of customised control over, for example, the routing, sizing, scheduling, acknowledgement, and disaster recovery of electronic records that is not present in current replication transport mechanisms of ERMSs.

The replication transport mechanism of the present invention may be particularly useful in configurations of electronic record management systems in which there is a master ERMS node and one or more slave ERMS nodes. In such a case, the master ERMS system may act as the central repository of original electronic records and handle all requests for changes to an electronic record. The master ERMS may evaluate and act upon change requests and then, using the replication transport mechanism, communicate the accepted changes to various slave ERMS nodes. In such a configuration, it is necessary to synchronize copies of electronic records stored in the systems when a user of one ERMS modifies electronic records and a user of another ERMS requires access to the up-to-date version of the electronic record. For example, it may be necessary to convey electronic records and associated metadata from master systems, which retain the originals of such electronic records, to slave or remote systems, which retain copies of originals that are updated on a regular basis. Likewise, the transport mechanism may also convey remote update data (e.g., requests for changes to master electronic records) from slave systems to master systems. Instructions from a master system to a slave system may be called master tasks, while instructions from a slave system to a master system may be called slave tasks. The master and slave tasks may be grouped together for the purposes of illustration into master/slave tasks.

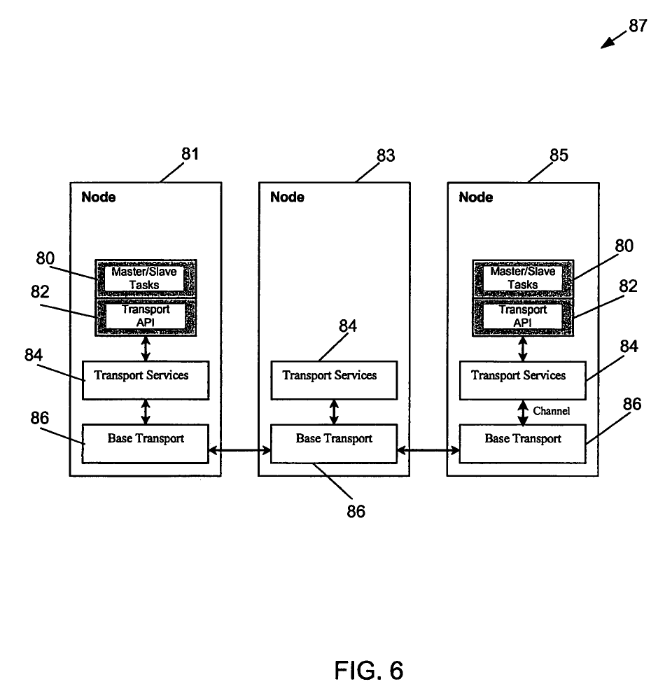

FIG. 6 illustrates an example of a configuration 87 for implementing the replication transportation mechanism feature of the present invention. As shown, configuration 87 includes three nodes 81, 83, and 85, and all three nodes include transport services mechanisms 84 and base transport mechanisms 86. Nodes 81 and 85 further include master/slave tasks 80 and a transport Application Programming Interface (API) 82, and, although these components are not illustrated in node 83, they may nevertheless be implemented in node 83 if suitable or desired. Obviously, any other suitable functions, including other instances of tasks 80, interface 82, and mechanisms 84 and 86, may be implemented in nodes 81, 83, and 85, and these nodes may be implemented as a single device (such as a computer or server) or any combination of devices. Nodes 81, 83, and 85 may be located geographically and/or logically near or remote to each other and may be in continuous or intermittent contact with one another. For example, nodes 81, 83, and 85 may be part of the same network (e.g., WAN, LAN, MAN) or they may be parts of disparate networks connected via various communications protocols (e.g., TCP/IP).

As described above, master/slave tasks 80 are instructions from a master or slave to a slave or master, respectively, that may be used to synchronize electronic records maintained on different nodes in an ERMS or alternatively between different nodes each of which is under the control of a different ERMS. Tasks 80 may be in any suitable format, such as XML metadata for example. Tasks 80 may specify any suitable information. For example, tasks 80 may be instructions that specify the identity of one or more electronic records to be synchronized, the action to be taken on that electronic record (e.g., create, edit, store or delete), and the specific changes to be made on that electronic record (e.g., edits to the text or other content or the identity of an attached electronic record including those changes). Obviously, any suitable tasks 80 may be used in accordance with the present invention.

Once a task 80 is generated by an ERMS module, or by any suitable mechanism, that task 80 may be output from the module or mechanism via transport API 82. Transport API 82 is any suitable application program interface that may be accessed by an ERMS module (or other mechanism) to communicate with, and/or configure transport services mechanism 84. For example, transport API 82 may be implemented using the MICROSOFT .NET class library. Transport API 82 may directly access a database or other storage mechanism (described below) in transport services mechanism 84 that acts as a repository of task information 80, acknowledgement messages (e.g., that a task was processed or rejected), and/or configuration data. Transport API 82 may access transport services mechanism 84 by a unique channel number (also described below) configured in the transport services mechanism.

Transport services mechanism 84 handles the routing, scheduling, sizing, and acknowledgement of the replication messages sent by each node. This routing, scheduling, sizing and acknowledgment is broadly configurable and the actual transportation may be accomplished using any suitable protocol and independently of the underlying technology used to move data in base transport mechanism 86. For example, transport services mechanism 84 may route tasks from node 81 to node 85 via another route (not shown) rather than routing the messages through node 83 either because the other route is faster, more secure, more reliable, or for any other suitable reason. The Transport Services mechanism 84 may control the schedule of when tasks are transmitted between nodes so that they are transmitted every half hour (or any other desired period of time) or when a certain number of tasks are ready to be transported, or based on a combination of time of day and volume of messages, for example. Mechanism 84 may also control the schedule of when tasks are transmitted so that tasks with higher priority are transmitted before tasks with lower priority, for example—in such a case, priority may be based on a manually assigned priority categories (e.g., high, low, and medium), chronological order, number of files in a folder, category of a document, order changes should be made to a document, etc., or any combination of the same. For example, in some embodiments, the priority of transmission may be based first on a categorical priority setting assigned to each electronic record associated with a task, and second on a chronological order in which the tasks were generated. As yet another example, mechanism 84 may cause copies of a task being transported through a node (e.g., node 83) to be held at that node until the task reaches the next node along the path so that the task cannot be inadvertently lost. Transport services mechanism 84 may also perform any necessary encryption and/or compression of items to be transported.

Transport services mechanisms 84 may communicate with one another through logical channels. Each channel may be assigned to correspond to a specific pairing of two or more transport services mechanisms. For example, a master ERMS at node 81 may communicate with a slave ERMS at node 83 via channel 1 at transport services mechanism 84 in node 81. The channel number in transport services mechanism 84 in node 83 for communication with node 81 may also be assigned to channel 1 (i.e., may be the same channel number) or may be any other suitable channel number (e.g., channel 2). In certain embodiments, each channel may be associated with an Internet Protocol address (or a network address) so that any given node in a system can communicate with another node in that system. Preferably, each channel may be used for communication in two directions, although, in certain embodiments, one-way channels may also be used. Morever, channels may be configured as broadcast channels so that any node can communicate simultaneously with many other nodes.

As described above, base transport mechanism 86 may be any suitable communication mechanism that may be used to deliver synchronization data from one node 81, 83, and 85 to another node 81, 83, and 85. For example, base transport mechanism 86 may be a communication network, such as a LAN, WAN, or the Internet, using TCP/IP. It may be desirable to split up data transmitted over base transport mechanism into portions, such as packets, as long as those portions can reliably be delivered and reassembled. Base transport mechanism 86 may also include functions for storing data to be transported from one node to another, for example, when the sending or receiving node is temporarily disconnected from a computer network or when immediate replication is otherwise not possible or not desired.

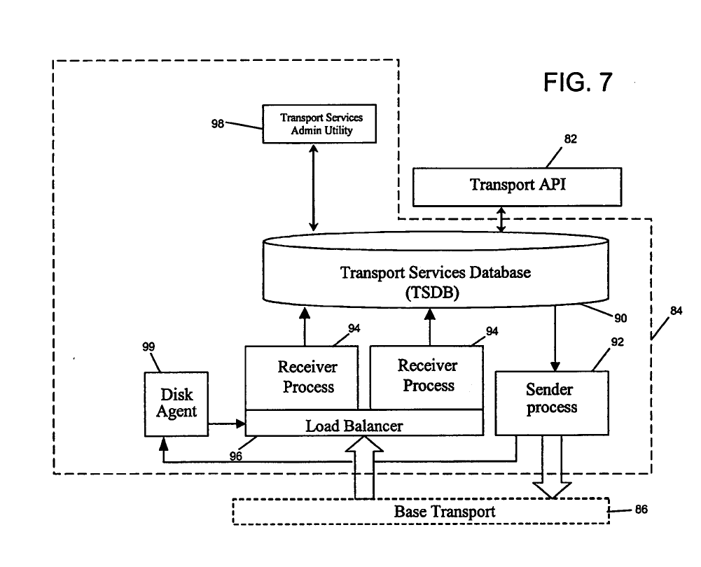

Turning to FIG. 7, transport services mechanism 84 is illustrated in greater detail. As shown, the transport services mechanism may include a transport services database (TSDB) 90, a sender process 92, receiver processes 94, a load balancer 96, an administration utility 98, and a disk agent 99. More particular, TSDB 90 may be any suitable data storage mechanism (such as a relational database) for storing and categorizing replication requests 80, and storing acknowledgement and change acceptance/rejection messages, configuration settings, and any other suitable data for the operation and control of transport services mechanism 84. For example, database 90 may be memory, a database server, a disk drive, a buffer, or any other suitable storage device. Sender process 92 may be any suitable process for sending data over base transport 86. For example, sender process 92 may be a TCP/IP process or any other suitable process. Receiver processes 94 may similarly be any suitable processes for receiving data over base transport 86. For example, receiver processes 94 may also be TCP/IP processes or any other suitable processes. Although one sender process 92 and two receiver processes 94 are illustrated, any suitable number of sender processes and receiver processes (including only one of each) may be used in accordance with the present invention. Load balancer 96 may be any suitable mechanism for balancing the traffic coming from other transport service mechanism between receiver processes 94, and for providing a single IP address for both receivers. For example, load balancer 96 may receive messages directed to its IP address, then perform network address translation (NAT) on those messages, select one of receiver processes 94 based upon any suitable mechanism (e.g., such as round robin, current load, etc.), and then forward the message to the selected receiver process 94. Administration utility 98 may be any suitable application that enables an administrator or other user to configure the transport services mechanism. For example, utility 98 may be used to configure the IP address and any other suitable parameters of transport services mechanism 84. Lastly, disk agent 99 may be used to transport replication data between two ERMSs without using base transport mechanism 86. For example, XML replication instructions and electronic records may sent from sender process 92 via agent 99 to a disk, or any other suitable portable media such as memory, at one ERMS so that those instructions can be transferred to another ERMS and read in from its agent 99 to a receiver process 94 via load balancer 96.

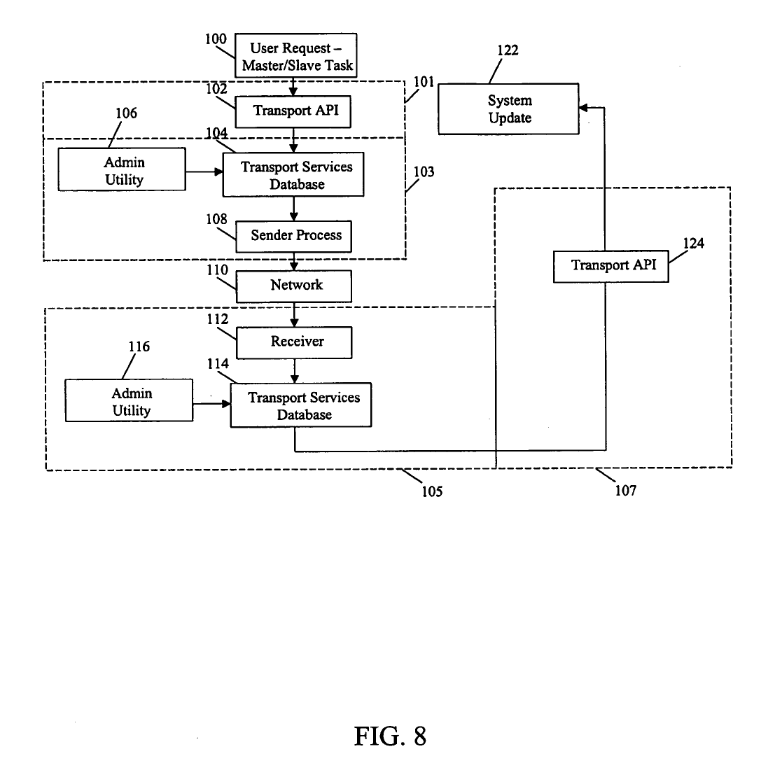

FIG. 8 illustrates an example of the flow of data in the transport replication mechanism provided in certain embodiments of the present invention. As shown, at step 100, a user may make a request at a master or slave ERMS to update or create an electronic record, resulting in a master/slave task being generated to update another ERMS. This task may then be passed by an ERMS module to transport API 101 at step 102. The transport API may then pass the task to the transport services mechanism database in a transport services mechanism 103 at step 104. As illustrated, transport services mechanism 103 may be controlled by an administration utility at step 106 by modifying the contents of the transport services mechanism database.

The sender process at step 108 retrieves the task from the database and transmits the task to the recipient via a computer network. The sender process may perform any necessary translation or reformatting of the task to facilitate transmission over the network. The sender process may also apply any restrictions on transmission of tasks, based on, for example, source or target node, user, account, device, content, route, time, or any other suitable factor or combination of factors.

At step 110, the network transfers the task from the sender process in transport services mechanism 103 to the receiver in transport services mechanism 105. The network may be any suitable base transport mechanism such as a WAN, LAN, or the Internet using the TCP/IP protocol. Although not illustrated here, the network at step 110 may include any number of nodes between the source node and the target node. In such a case, each node may temporarily receive, store in its database, and send any of the tasks be sent over the network.

After the network transports the data, the receiver at step 112 receives the data via a load balancer (not pictured). The receiver may strip headers or other data added by the sender and/or assemble and confirm arrival of data packets making up the data. The receiver next passes the data to a transport services database at step 114. Like the database in mechanism 103, the database in mechanism 105 may be controlled by an admin utility at step 116. The transport API at step 124 may next retrieve the data from the database and then pass the data to an ERMS module that performs a system update at step 122.

Remote Update of Replicated Data

As described above, an ERMS in accordance with the present invention may also provide a replication mechanism that enhances data integrity by ensuring that modified electronic records on remote systems stay synchronized with the master copies of those records on a master system.

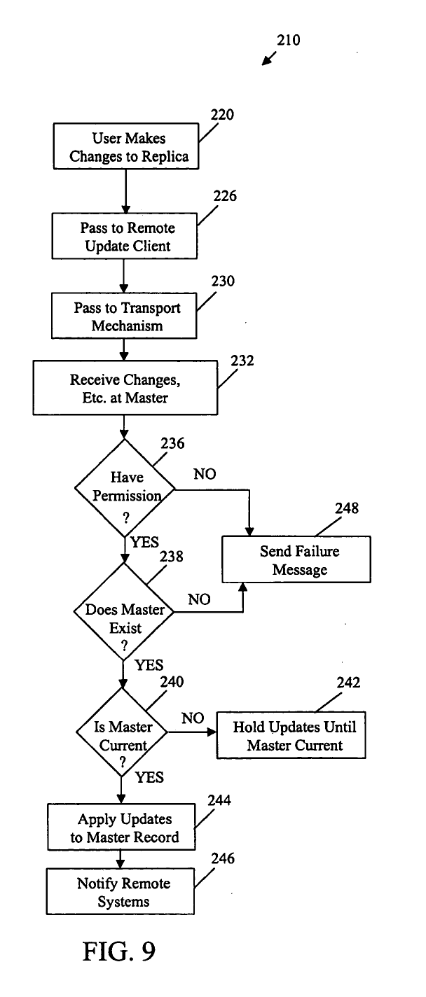

FIG. 9 illustrates an example of a process 210 for performing replication in accordance with certain embodiments of the present invention. As shown, at step 220, a user makes changes to a replica of an electronic record. These changes may be made through any suitable mechanism, such as MICROSOFT WORD, MICROSOFT POWERPOINT, MICROSOFT EXCEL, or any other suitable software or hardware. After the user has completed making the changes, the changed replica will be passed to a remote update client at step 226 when the user attempts to save the changes.

Upon receiving the changed replica of the electronic record, the remote update client will create a package of XML metadata describing the proposed changes and pass that package to a transport mechanism at step 230. Preferably, the package is transported via the remote transport mechanism described above, however any suitable mechanism for conveying the changes to the master ERMS may be used. Part of the XML metadata may be a unique system id for the remote ERMS node so that the master ERMS node knows which remote system initiated the proposed changes to the master electronic record. Any other suitable information, such as a user id of the user that entered the changes to the replica of the electronic record, may also be included in the XML metadata. Obviously, although XML metadata is described herein as being used to describe the changes made to the replica and any other suitable information, any mechanism for containing this information may be used in accordance with the present invention.

Next, at step 232, the package of changes and any accompanying information are received at the master ERMS, and a master list of changes is compiled. The master list may consist of changes from a single request from a single remote ERMS, or may include one or more requests from one or more systems. The master list of changes may include an identity of the system and/or user that proposes each change to the master electronic record.

Process 210 may then determine at step 236 whether the remote ERMS, or the user, has permission to update the master electronic record at step 236. If the remote ERMS (or user) does not have permission, then the master ERMS may send a failure message to the remote ERMS at step 248. Otherwise, process 210 may check whether the master of the electronic record exists at the master ERMS at step 238. If it is determined at step 238 that the master does not exist, process 210 branches to step 248 and sends a failure message to the remote ERMS. Otherwise, process 210 continues to step 240 determine whether the master is current. The master might not be current for example if other changes to the master are pending. If the master is not current, then process 210 may hold the changes until the master becomes current, for example because the pending changes were made to the master. Otherwise, the updates are applied to the master at the master ERMS at step 244.

As shown at step 246, once changes have been made to the master, process 210 may notify the remote ERMS(s) that the changes have been made to the master electronic record. This notification may be used to update the replicas at each of the remote systems with the changes to the master electronic record, may be used only to notify the remote system that requested the changes that the changes were accepted, may be used only to notify the remote systems that did not request the changes that changes to the master electronic record were made, or may be used for any other purpose. This notification may include any suitable information, such as an identifier of the request to update the master electronic record, an identifier of the remote system and/or user that updated the record, etc. The notification may be used to update the replicas at each of the remote systems by including a complete copy of the master electronic record, or by including a package of change information and any accompanying information (e.g., similarly to the XML metadata package used to convey the changes from the remote system to the master system).

Retention Mechanism

As described above, an ERMS in accordance with the present invention may also provide an improved records retention mechanism for managing the lifecycle of electronic records by resolving candidate document disposal schedules into a single schedule to be applied to the electronic record and applying that schedule to one or more storage devices with built-in document retention functions. In some embodiments, the retention mechanism of the ERMS may be a software application that manages electronic records according to rules and definitions created by a record manager within an organization who is responsible for ensuring records retention and disposal. This software mechanism may also interact with electronic records retention rules maintained by other hardware elements of the system, such as those maintained by EMC's CENTERA storage management products when such products are used in the system. The ERMS may support a full range of disposal options through the retention mechanism such as export to an external archive, deletion, retention and review at a later date, and/or any other suitable options.

Each disposal schedule may generally consist of a trigger event, a retention period and a disposal action. The trigger event may be an incident such as document creation, the declaration of the document as an electronic record by the ERMS, archiving, processing, transporting, updating or other occurrence which instructs the ERMS that a particular electronic record may need to be retained. The retention period may be a set period of time that runs from the trigger event to a specified end date. The disposal action may be a specific action to be performed on the electronic record upon the expiry of the retention period. For example, the action may to perform secure deletion of the electronic record or to archive the electronic record onto tape or other media. As another example, the action may be to take some action on the electronic record and restart the retention period.

Because of differing electronic records retention requirements, many electronic records may have multiple disposal schedules associated with them. Certain embodiments of the present invention provide a method for resolving candidate disposal schedules into a single schedule to be applied to the electronic record.

FIG. 9 illustrates one example of an architecture 300 for implementing a retention mechanism in accordance with certain embodiments of the invention. As shown, architecture 300 includes a dynamic trigger event monitor 310 that may query the system for an incident such as an electronic record creation, archiving, processing, transporting, updating or other event which may be designated by a records manager using a rules composer 320. Rules composer 320 may be a graphic user interface into the ERMS, a software module, or other suitable means to configure the retention mechanism.

If trigger event monitor 310 identifies an event, it may pass information about the electronic record to a disposal schedule creation module 312. Disposal schedule creation module 312 may be a software module or other suitable mechanism that receives information about an electronic record and disposal rules, and modifies attributes of the electronic record to create a disposal schedule. This module may also contain an algorithm for resolving multiple candidate disposal schedules into a single schedule that governs the electronic record. After the disposal schedule is created, disposal schedule creation module 312 may pass the electronic record to electronic storage medium 314 for storage.

Electronic record storage 314 may be a magnetic storage device, a solid-state storage device, an optical storage device, a physical medium used for storage, or any other suitable storage device. In certain embodiments, for example when used with EMC's CENTERA and CENTERA CE+ products, the actual physical storage device itself may create and maintain disposal schedules for electronic records stored on the device. The disposal schedule creation module 312 may also contain an algorithm to query such disposal schedules as part of the process of resolving candidate disposal schedules into a single schedule that governs the electronic record. The electronic record may reside in electronic storage 314 until the disposal condition occurs. Electronic record query logic 316 may check electronic record storage 314 at various times to ensure disposal schedules are being met. Electronic record query logic 316 may be a software module or other suitable device that may check electronic record storage 314 and evaluate disposal schedules based on rule from rules composer 320.

If a record is found to meet the disposal requirements, the record may be selected by electronic record query logic 316 to be passed from electronic record storage 314 to disposal action module 318. Disposal action module 318 may evaluate the disposal schedule and may determine the appropriate action for the electronic record. The appropriate action may be disposal, archiving or other suitable actions. In some embodiments, electronic record query logic 316 may handle the disposal action. In other embodiments, electronic record storage 314 may handle the disposal action based on the instructions of electronic record query logic 316 or based on any other suitable mechanism, such as internal disposal action settings.

Once an electronic record is declared within the ERMS, in some embodiments, the record may at regular intervals be queried to determine which of any disposal schedules may be relevant to the electronic record. As discussed above, these disposal schedules may then be processed using to determine which of the candidate disposal schedules should be applied to the record in question. For example, the priorities of different applicable disposal schedules may be compared, and the disposal schedules applied in order or priority, such that a lower-priority disposal schedule does not override a higher-priority disposal schedule. As another example, the disposal schedules may be compared and the disposal schedule that would cause an electronic record to be retained for either the longest or the shortest period of time may be selected.

Where storage hardware also supports the creation and maintenance of its own disposal schedules, such as in the case of EMC's CENTERA and CENTERA CE+ storage products, these disposal schedules may be queried as well to ensure that the requirements of such disposal schedules are taken into account in setting the disposal schedule for a record. When the physical hardware can be programmed to automatically retain a record for a minimum period of time, or to automatically delete a record after some period of time, the hardware may be programmed in accordance with the invention to maintain control by the electronic record query logic 316. For example, if the storage hardware needs to be programmed with a minimum retention setting, the disposal schedule creation module 312 may program the hardware with a minimum retention setting of “one day” (or any other suitable setting) for an electronic record so that record can be deleted by the electronic record query logic 316 on any given day. If the electronic record query logic 316 determines that a record should not yet be deleted, the logic may then reset the retention setting for the hardware for one more day and then repeat the query process on the following day.

Other embodiments, extensions, and modifications of the ideas presented above are comprehended and should be within the reach of one versed in the art upon reviewing the present disclosure. Accordingly, the scope of the present invention in its various aspects should not be limited by the examples presented above. The individual aspects of the present invention, and the entirety of the invention should be regarded so as to allow for such design modifications and future developments within the scope of the present disclosure. The present invention is limited only by the claims that follow.

What is claimed is:

1. A method for capturing electronic records, comprising:
receiving an electronic record from a process chain initiator at an electronic records management system;
selecting at least one process chain definition;
based on the selected at least one process chain definition, selecting at least one element to be processed on the electronic record; and
executing the selected at least one element on the electronic record.

2. The method of claim 1, wherein the electronic record is an email.

3. The method of claim 1, wherein the electronic record is an instant messaging conversation.

4. The method of claim 1, wherein the process chain definition is stored in a configuration file.

5. The method of claim 1, wherein the element is a rules element.

6. The method of claim 1, wherein the element is a storage element.

7. The method of claim 1, wherein the element is a custom element.

8. The method of claim 1, wherein the element is a characterization element.

9. A method for capturing electronic records in an electronic record management system, comprising:
monitoring for the occurrence of an electronic record;
in response to the electronic record being detected, creating metadata for the electronic record;
comparing at least one of the electronic record and the metadata to at least one rule; and
if the rule is satisfied, performing a custom element operation on at least one of the electronic record and the metadata.

10. The method of claim 9, wherein the electronic record is an email.

11. The method of claim 9, wherein the electronic record is an instant messaging conversation.

12. The method of claim 9, wherein the monitoring is continuous.

13. The method of claim 9, wherein the monitoring is periodic.

14. The method of claim 9, wherein the creating metadata comprises extracting data for the metadata from the electronic record.

15. The method of claim 9, wherein the creating metadata comprises obtaining data for the metadata from an external source.

16. The method of claim 9, further comprising receiving the rule from a user.

17. The method of claim 9, wherein the custom element determines additional metadata for the electronic record.

18. The method of claim 9, wherein the custom element determines a classification of the electronic record.

19. The method of claim 9, wherein the custom element determines a location in which to store the electronic record.

20. The method of claim 9, further comprising storing at least one of the electronic record and the metadata if the rule is satisfied.

21. A method for replicating data among a plurality of electronic records management systems, comprising:
receiving data to be replicated from a first electronic records management system through a first application program interface at a first node and storing the data in a first database at the first node;
retrieving the data from the first database and sending the data through a base transport from the first node to a second node;
receiving the data at the second node and storing the data in a second database at the second node;
retrieving the data from the second database and sending the data through the base transport from the second node;
receiving the data at an nth node and storing the data in an nth database at the nth node; and
retrieving the data from the nth database and providing the data through a second application program interface to a second electronic records management system.

22. The method of claim 21, further comprising retaining a copy of the data at a database until the data has been acknowledged as being received at the nth database.

23. The method of claim 21, further comprising comparing the data to other data to determine which has priority for replication.

24. The method of claim 21, wherein the data is sent from the second node directly to the nth node.

25. The method of claim 21, wherein the data is sent from the second node to the nth node via at least one intermediate node.

26. A method for updating electronic records through an electronic records management system, comprising:
providing a master electronic record at a first node;
providing a replica electronic record that is a replica of the master electronic record at a second node;
permitting a first user to make modifications to the master electronic record;
permitting a second user to make modifications to the replica electronic record;
transmitting the modifications to the replica electronic record from the second node to the first node;
at the first node, comparing the modifications to the master electronic record to the modifications to the replica electronic record to determine if the modifications to the replica electronic record will be entered; and
at the first node, determining whether to reject the modifications to the replica electronic.

27. The method of claim 27, wherein the determining whether to reject the modifications to the replica electronic record is based on whether the modifications to the replica electronic record conflict with modification to the master electronic record.

28. The method of claim 27, wherein the determining whether to reject the modifications to the replica electronic record is based on whether the second user has permission to modify the master electronic record.

29. The method of claim 27, further comprising accepting the modifications to the replica electronic record and applying the modifications to the master electronic record.

30. The method of claim 27, further comprising rejecting the modifications to the replica electronic record.

31. A method for retaining electronic records in an electronic records management system, comprising:
comparing multiple disposal schedules applicable to an electronic record to determine a single disposal schedule for the electronic record;
setting a disposal configuration of a storage device that is compatible with the single disposal schedule;
storing the electronic record in the storage device; and
taking a disposal action on the electronic record in accordance with the single disposal schedule.

32. The method of claim 31, wherein the disposal action includes deleting the electronic record.

33. The method of claim 31, wherein the disposal action includes archiving the electronic record.

34. The method of claim 31, wherein the storage device is an EMC CENTERA product.

35. The method of claim 31, further comprising periodically resetting the disposal configuration of the storage device so as to extend the retention period of the electronic record on the storage device.
